(19) United States
(12) Patent Application Publication
(10) Pub. No.: US 2017/0337758 A1
(43) Pub. Date: Nov. 23, 2017

(54) AUTOMATIC UNLOCK DEVICE AND METHOD

(71) Applicant: Schlage Lock Company LLC, Carmel, IN (US)

(72) Inventors: John Robert Ahearn, Pasadena, CA (US); Joseph Wayne Baumgarte, Carmel, IN (US); Gabriel Daniel Focke, Sunman, IN (US); Michael Scott Henney, Indianapolis, IN (US)

(21) Appl. No.: 15/670,345

(22) Filed: Aug. 7, 2017

Related U.S. Application Data
(63) Continuation of application No. 13/968,662, filed on Aug. 16, 2013.
(60) Provisional application No. 61/684,118, filed on Aug. 16, 2012.

(51) Int. Cl. G07C 9/00

(52) U.S. Cl. CPC G07C 9/00174; G07C 9/00309; G07C 2209/63; G07C 2009/00357

(57) ABSTRACT

A method is provided for operating an electronic lock system having a long range capability and a close proximity range capability, including identifying via the long range capability an initial contact between an electronic lock and a credential, authenticating the credential via the electronic lock, and unlocking the electronic lock when the authenticated credential is sensed via the close proximity range capability. An electronic lock system is also provided which includes a credential, an electronic lock configured to communicate with the credential and having a long range capability and a close proximity range capability. The long range capability identifies initial communication between the electronic lock and the credential, the electronic lock authenticates the identified credential, and the electronic lock unlocks when the authenticated credential is sensed via the close proximity range capability.

### CROSS-REFERENCE TO RELATED APPLICATIONS

The present application claims the benefit of U.S. Provisional Patent Application No. 61/684,118 filed on Aug. 16, 2012, the contents of which are incorporated herein by reference in their entirety.

### TECHNICAL FIELD

The present invention generally relates to an automatic unlock device and method, and more particularly, but not exclusively, to an automatic unlock device and method for unlocking a door in range.

### BACKGROUND

Automatic unlock devices may be used to unlock for example a door based on presentation of a ranged credential. Some existing devices have various shortcomings relative to certain applications. Accordingly, there remains a need for further contributions in this area of technology.

### SUMMARY

One embodiment of the present invention is a unique automatic unlock device. Other embodiments include apparatuses, systems, devices, hardware, methods, and combinations for automatically unlocking a door for example. Further embodiments, forms, features, aspects, benefits, and advantages of the present application shall become apparent from the description and FIGURES provided herewith.

### BRIEF DESCRIPTION OF THE FIGURES

FIG. 1 is a diagram illustrating an automatic unlock device and method.

### DETAILED DESCRIPTION OF THE ILLUSTRATIVE EMBODIMENTS

For the purposes of promoting an understanding of the principles of the invention, reference will now be made to the embodiments illustrated in the drawing and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

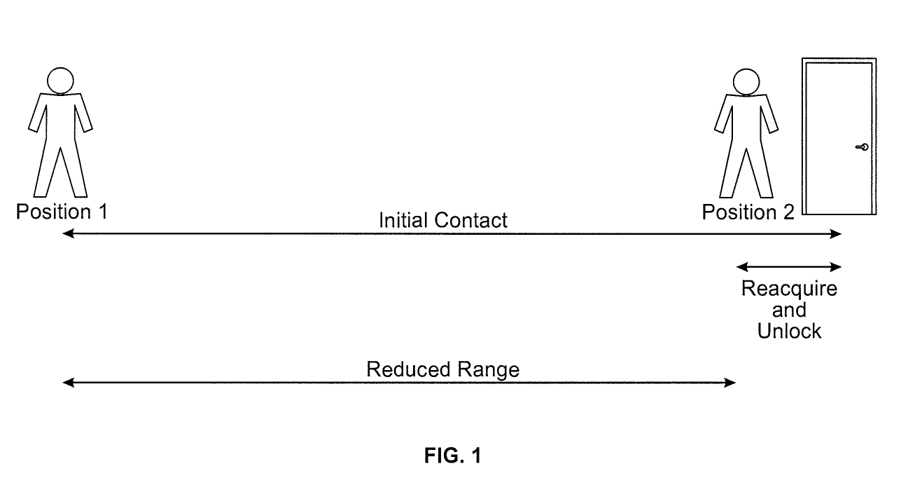

FIG. 1. illustrates an automatic unlock device and method which includes communication between a lock and a credential. In the illustrated embodiment, the lock is incorporated into, or in close proximity to, a door, as shown at the far right of FIG. 1. The credential may be incorporated in a user card for example.

The lock includes a long range capability. FIG. 1 illustrates an example of the long range capability. The long range is indicated by “initial contact” in FIG. 1, where the credential is located for example at the Position 1 at the far left of the “initial contact” arrow. When the credential is at the long range from the lock, the lock's long range capability identifies (i.e. establishes initial contact with) the credential. The lock then authenticates the credential.

The lock also includes a close proximity range capability. FIG. 1. illustrates an example of the close proximity range capability. The close proximity is indicated by “reacquire and unlock” in FIG. 1, where the credential is located for example at the Position 2 at the left of the “reacquire and unlock” arrow. When the credential is at the close proximity range to the lock, the lock's close proximity range capability automatically unlocks the door.

In one embodiment, when the credential is fully authenticated and any other activity is complete, the range at which the lock's close proximity range capability can unlock the door can be reduced. In a further embodiment, the time between the initial presentation of the credential and the credential's close proximity range to the lock is used to authenticate, update, and pass audits, for example. In still another embodiment, the time between unlocking of the door and loss of communication between the lock and credential may be used for continuing such updates.

In another embodiment, the lock delays auto-unlock from the time of initial credential presentation until the credential is at the close proximity range to the lock. Thus, access is restricted until the time for the user to use the door. In one embodiment, the longer the connection between the initial credential presentation and the door unlocking, the more time is provided for computation, authentication, and encryption, for example.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item. unless specifically stated to the contrary in the claim. When the language “at least a portion” and/or “a portion” is used the item can include a portion and/or the entire item unless specifically stated to the contrary.

What is claimed is:

1. A method of operating an electronic lock system having a long range capability and a close proximity range capability, the method comprising:
identifying via the long range capability an initial contact between an electronic lock and a credential;
authenticating the credential via the electronic lock; and
unlocking the electronic lock when the authenticated credential is sensed via the close proximity range capability.

2. The method of claim 1, further comprising reducing the range at which the close proximity range capability results in unlocking of the electronic lock after the authenticating.

3. The method of claim 1, further comprising passing of information between the electronic lock and the credential after the identifying.

4. The method of claim 3, wherein the passing of information occurs before the unlocking.

5. The method of claim 3, wherein the passing of information occurs after the unlocking.

6. The method of claim 7, wherein the passing of information occurs until losing communication between the electronic lock and the credential.

7. The method of claim 3, wherein the passing of information includes the authenticating.

8. The method of claim 3, wherein the passing of information includes providing an update from the credential to the electronic lock.

9. The method of claim 3, wherein the passing of information including providing audit information from the electronic lock to the credential.

10. The method of claim 1, further comprising encrypting information after the identifying and before the unlocking.

11. The method of claim 1, further comprising computing information after the identifying and before the unlocking.

12. The method of claim 1, wherein the unlocking comprises automatically unlocking the electronic lock when the authenticated credential is sensed via the close proximity range capability.

13. The method of claim 1, further comprising incorporating the credential into a user card.

14. The method of claim 1, further comprising using the electroniclock in association with a door.

15. An electronic lock system, comprising:
a credential; and
an electronic lock configured to wirelessly communicate with the credential, the electronic lock having a long range capability and a close proximity range capability; and
wherein the long range capability of the electronic lock is configured to identify initial communication between the electronic lock and the credential;
wherein the electronic lock is configured to authenticate the identified credential; and
wherein the electronic lock is configured to unlock when the authenticated credential is sensed via the close proximity range capability of the electronic lock.

16. The system of claim 15, wherein the electronic lock is configured to automatically unlock when the authenticated credential is sensed via the close proximity range capability of the electronic lock.

17. The system of claim 15, wherein the credential is incorporated into a user card.

18. The system of claim 15, wherein the electronic lock is associated with a door.

19. The system of claim 15, wherein the electronic lock and the credential are configured to pass information therebetween after identification of the initial communication between the electronic lock and the credential.

20. An apparatus, comprising:
an electronic lock having a long range capability and a close-proximity range capability, the electronic lock configured to identify a credential via the long range capability, authenticate the credential, and automatically unlock when the credential is sensed by the close proximity range capability.
